(19) United States
(12) Patent Application Publication
(10) Pub. No.: US 2010/0264187 A1
(43) Pub. Date: Oct. 21, 2010

(54) Removable tire carrier

(76) Inventor: Mark Buskirk, Alliance, NE (US)

Correspondence Address: Gene R. Woodle, 3516 Woodle Drive, Rapid City, SD, 57702, US

(21) Appl. No.: 12/386,733

(22) Filed: Apr. 21, 2009

(51) Int. Cl. B62D 43/02; B60R 9/06

(52) U.S. Cl. 224/502; 224/42.21; 224/519; 224/42.26

(57) ABSTRACT

Embodiments of a removable tire carrier are disclosed which may be removably affixed to the receiver of a conventional trailer hitch on a conventional vehicle. The tire carrier may be rotated in the plane of the rear of the vehicle such that a portion of the tire carrier touches the ground. A flat or otherwise damaged tire may then be rolled onto the tire carrier and secured to the tire carrier. The tire carrier may be rotated back into position for transporting the tire.

### BACKGROUND OF THE INVENTION

1. Field of the Invention

The present invention relates generally to wheeled vehicles and more specifically to a removable tire carrier which may be affixed to a vehicle trailer hitch and used to transport a tire.

2. Background Information

In all the years since people began using inflatable tires, they have been dealing with flat tires. A majority of conventional transport vehicles now carry a spare tire which may be used to replace a tire which has become flat or is otherwise not in a good condition for continued use. Most often the damaged or flat tire is taken to a repair shop and then returned to service.

In the case of most family vehicles, it is a relatively simple matter to change a flat tire and lift the damaged tire into the trunk or onto a tire carrier affixed to the outside of the vehicle. In some cases, however, a damaged tire can be sufficiently heavy that it is difficult to lift a damaged tire onto a place where it may be transported. This is particularly true in the case of heavy equipment or in cases such as with center pivot irrigation. A typical center pivot irrigation unit may have up to eight pairs or tires and each tire can weigh up to two hundred pounds, especially when covered with mud which is often the case. With so many tires in use, a center pivot irrigator has to replace a great number of tires over the course of an irrigation season.

A number of tire carriers have been invented over the years which attempt to assist an operator in lifting a tire into a position to be transported. The patent to Newbill (U.S. Pat. No. 6,659,318; Dec. 9, 2003), for example, discloses a spare wheel carrier which allows a spare tire to rotate on a about the end of a support arm in a plane parallel to the back of the vehicle. A motor is provided to assist in lifting the weight of the tire. Several devices such as that disclosed in Skinner (U.S. Pat. No. 6,918,520; Jul. 19, 2005) provide a method for affixing the device to the receiver of a trailer hitch and allow a spare tire to be rotated on a hinge or pin away from the back of the vehicle and downward.

The removable tire carrier of the instant invention is believed to solve, in a new and unique fashion, many problems relating to removably affixing a tire or similar object to a carrier such that it may be transported without requiring an operator to lift the tire. The tire carrier of the instant invention may be removably affixed to the receiver of a trailer hitch and provides a tilting tire frame which may be tilted such that one end of the frame touches the ground and a tire may be rolled onto the frame.

The ideal removable tire carrier should be capable of being removably affixed to the receiver of a trailer hitch.

The ideal removable tire carrier should also be capable of allowing an operator to place a tire or similar object onto the tire carrier without requiring the operator to lift the tire.

The ideal removable tire carrier should be capable of safely and easily transporting a tire or similar object.

The ideal removable tire carrier should also be inexpensive, rugged, and easy to use.

These and other features of the invention will become apparent when taken in consideration with the following detailed description and the drawings.

### SUMMARY OF THE INVENTION

The removable tire carrier of the instant invention includes a hitch portion which may be removably affixed to the receiver of a trailer hitch on a vehicle. A hub is provided which is affixed to the hitch portion and allows the tire carrier to rotate about the hub in a plane parallel to the rear of the vehicle. A frame is rotatably affixed to the hub. The frame may be rotated from a transport position in which the bottom of the frame is parallel to the ground to a loading position where one end of the bottom of the frame touches the ground and the frame is tilted.

When the frame is in the loading position, a tire or similar object, may be rolled onto the frame without the need for the operator to lift the tire. A removable bracket is provided which may be used to secure the tire within the frame. The frame may then be rotated about the hub until the bottom of frame is once again parallel to the ground. The frame may be secured in this position by a pin located on the hub. The tire may then be transported as required using the vehicle. A tire may be removed from the frame by reversing the procedure outlined above.

The removable tire carrier of the instant invention is described above as being used with a trailer hitch and used to transport a tire, but the device could be easily adapted to carry objects other than tires and affixed to the rear of a vehicle without using a trailer hitch.

One of the major objects of the present invention is to provide a removable tire carrier capable of being removably affixed to the receiver of a trailer hitch.

Another objective of the present invention is to allow an operator to place a tire or similar object onto the tire carrier without requiring the operator to lift the tire.

Another objective of the present invention is to provide a device capable of safely and easily transporting a tire or similar object.

Another objective of the present invention is to provide a device which is inexpensive, rugged, and easy to use.

These and other features of the invention will become apparent when taken in consideration with the following detailed description and the drawings.

### BRIEF DESCRIPTION OF THE DRAWINGS

FIG. 1 is a rear view of the removable tire carrier of the instant invention in the transport position;

FIG. 2 is a side view of the removable tire carrier of the instant invention;

FIG. 3 is a side view of the removable tire carrier of the instant invention in loading position;

FIG. 4 is a rear detail view of the hub of the instant invention; and

FIG. 5 is a side detail view of the hub of the instant invention.

### DESCRIPTION OF A PREFERRED EMBODIMENT

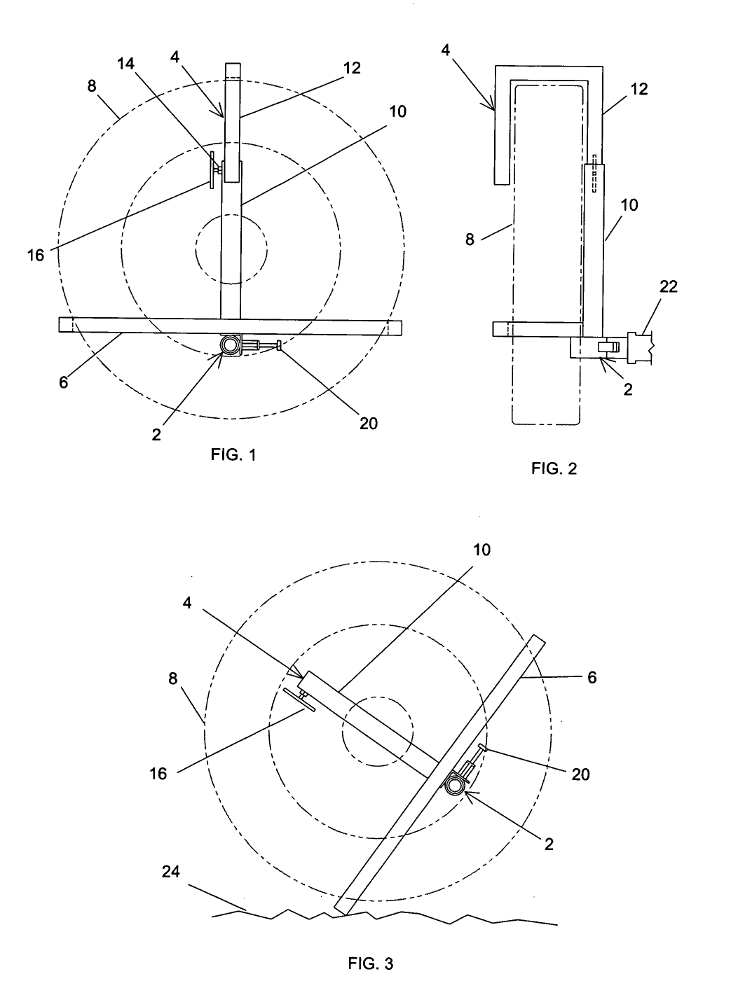

Referring to the drawings, FIGS. 1 through 5 the removable tire carrier of the instant invention is shown. The device is shown and described below as being used to load, unload, or transport a tire using a conventional vehicle, but it could be used to load and transport a variety of objects. The device is also described as being removably affixed to the receiver of conventional trailer hitch on a conventional vehicle, but it could easily be affixed to such a vehicle in a different manner.

Referring now to FIG. 1, a rear view of the removable tire carrier of the instant invention in the transport position. A hub 2 may be removably affixed to the receiver of a conventional trailer hitch of a conventional vehicle. The hub 2 and the trailer hitch are described in more detail below. A frame 4 is rotatably affixed to the hub 2 and may rotate about said hub 2. The frame 2 includes a lower frame 6 which is generally parallel to the ground and has the general shape of a hollow rectangle. The interior of the lower frame 6 is slightly shorter than the width of the typical tire 8 which is to be carried. The width the interior of said lower frame 6 is slightly wider than the width of the tire 8. An upright bracket 10 is also part of said frame 4 and protrudes upward from said hub 2 such that it is between said tire 8 and the rear surface of the vehicle (not shown). A top bracket 12 is removably affixed to the top of the upright bracket 10. The top bracket 12 is in place when transporting said tire 8, but may be removed to allow said tire 8 to be loaded onto or unloaded from said frame 4.

Still referring to FIG. 1, a threaded nut 14 is affixed to one side said upright bracket 10 near the top of said upright bracket 10. There is a hole (not shown) through the wall of said upright bracket 10 at the location of the threaded nut 14. A handle 16, having a threaded end, may be screwed into said threaded nut 14. When screwed in, the handle 16 engages a portion of said top bracket 12 which slides inside said upright bracket 10 and said handle 16 acts to hold said top bracket 12 in place and secures said tire 8 within said frame 4. Said handle 16 may be screwed out to disengage said top bracket 12 and said top bracket 12 removed to allow said tire 8 to be either placed within or removed from said frame 4. A pin 20 may be used to secured said frame 4 in position with said lower frame 6 horizontal which is referred to as the transport position. The structure and actions of the pin 20 are described in greater detail below.

Referring now to FIG. 2, a side view of the removable tire carrier of the instant invention is shown. This view better shows the relationship and configuration of said hub 2, said frame 4, said lower frame 6, said upright bracket 10, said tire 8, and said top bracket 12. Said tire 8 fits within said lower frame 6 and is held in place by placement of said top bracket 12 which has the general shape of an inverted “U.” This view further shows that said hub 2 may be removably inserted into a trailer hitch receiver 22. Said hub 2 may be secured within the receiver 22 in a number of conventional ways, but usually there is a receiver pin (not shown) which passes through both said receiver 22 and said hub 2.

Referring now to FIG. 3 a side view of the removable tire carrier of the instant invention in loading position is shown. Said handle 16 is unscrewed such that said top bracket 12 may be removed. Said pin 20 is disengaged which allows said frame 4 to rotate about said hub 2. Said frame 4 may be rotated in either direction until one end of said lower frame 6 touches the ground 24. Said tire 8 may then be rolled away from said frame 4 without requiring an operator to lift said tire 8. If said tire 8 has not previously been loaded onto said frame 4, said tire 8 may be rolled onto said lower frame 6 as shown. Top bracket 12 may be secured within said upright bracket 10 using said handle 16 as described above to secure said tire 8 within said frame 4.

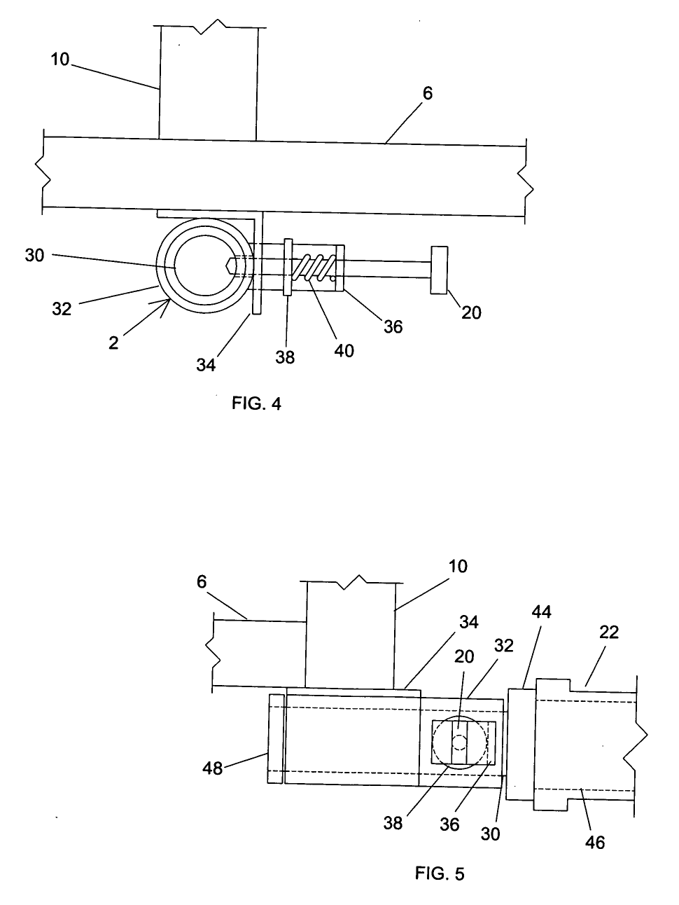

Referring now to FIG. 4 a rear detail view of the hub of the instant invention is shown. Said hub 2 includes an inner sleeve 30 which is a part of said hub 2 affixed to the receiver 22 and does not rotate. An outer sleeve 32 fits over the inner sleeve 30 and may rotate about said inner sleeve 30. Both said inner sleeve 30 and the outer sleeve 32 have the general shape of a hollow cylinder. A brace 34, having the shape of a piece of angle iron is affixed to said outer sleeve 32 with one leg of the brace 34 being affixed to the top of said outer sleeve 32 and the other leg being affixed to the side of said outer sleeve 32. Said lower frame 6 and said upright 10 are also affixed to said brace 34 such that they may also rotate about said inner sleeve 30.

Still referring to FIG. 4, a clip 36 is affixed to and protrudes outward from said outer sleeve 32. The clip 36 has the shape of an “L” with the longer leg being affixed to said outer sleeve 32 and the shorter leg being parallel to the longitudinal axis of said outer sleeve 32 and said inner sleeve 30. Said pin 20 fits through a hole in the shorter leg of the clip 36 and protrudes inward through aligned holes in said inner sleeve 30 and said outer sleeve 32. With said pin 20 in this position, said outer sleeve 32 is locked in place and may not rotate about said inner sleeve 30. A ring 38 is affixed to said pin 20 between the shorter leg of said clip 36 and said outer sleeve 32. A spring 40 is interposed between the ring 38 and the shorter leg of said clip 36 and tends to press said pin 20 into the holes through said inner sleeve 30 and said outer sleeve 32. That is, said pin 20 may be pulled away from said outer sleeve 32 and the force of the spring 40 overcome to unlock said outer sleeve 32 from said inner sleeve 30 and allow said outer sleeve 32 to rotate about said inner sleeve 30. This allows said lower frame 6 to be rotated and said tire 8 be loaded as described under FIG. 3 above.

Referring now to FIG. 5 a side detail view of the hub of the instant invention is shown. A mount 44 is affixed to the end of said inner sleeve 30 closest to said receiver 22. A fixture 46 is affixed to the mount 44 and fits within said receiver 22 to attach the removable tire carrier to said receiver 22. The method of attachment of the fixture 46 to said receiver 22 may vary according to the type of trailer hitch, but most often there is a pin (not shown) which is pushed through aligned holes through said receiver 22 and said fixture 46. This view shows that said clip 36 is affixed to said outer sleeve 32 between said brace 34 and said receiver 22. Said inner sleeve 30 is longer than said outer sleeve 32. During manufacture, after said outer sleeve 32 has been slide over said inner sleeve 30, a retaining ring 48 is affixed to the end of said inner sleeve 30 away from said receiver 22 which serves to hold said outer sleeve 32 in place over said inner sleeve 30.

An operator may use said handle 16 to remove said top bracket 12. The operator may then pull said pin 20 which releases said outer sleeve 32 from said inner sleeve 30 and allows said frame 4 to rotate about said inner sleeve 30. Said frame 4 may then be rotated in either direction until one end of said lower frame 6 contacts the ground in loading position. The operator may then roll said tire 8 onto said frame 6 and secure said tire 8 to said frame 4 by using said handle 16 to reattach said top bracket 12. Said lower frame 6 may be rotated back to the horizontal position and said spring 40 pushes said pin 20 into the now aligned holes in said inner sleeve 30 and said outer sleeve 32 and locks said frame 4 in transport position with said lower frame 6 in a horizontal position. Said tire 8 may be unloaded by removing said top bracket 12, pulling said pin 20, rotating said lower frame 6 until it touches the ground, and then rolling said tire 8 from said frame 4. As may be seen from the above, said tire 8 may be either loaded or unloaded without lifting said tire 8.

In the preferred embodiment of the removable tire carrier, all parts are conventional and made from steel, but other materials having similar characteristics of strength, rigidity, and weather resistance could be used. Said lower frame 6, said upright bracket 10, and said top bracket 12 are made from tubular steel with a square cross section. Said tire 8 and said receiver 22 are not considered part of the invention. Said inner sleeve 30 and said outer sleeve 32 are made from standard sized steel pipe. Any exposed surfaces may be painted or powder coated to improve appearance and weather resistance.

While preferred embodiments of this invention have been shown and described above, it will be apparent to those skilled in the art that various modifications may be made in these embodiments without departing from the spirit of the present invention.

I claim:

1. A tire carrier which may be affixed to a conventional vehicle and used to load, unload, or transport a tire, comprising:
(1) a hub and affixing means for affixing the hub to the rear of a vehicle; said hub being capable of rotating in the plane of the surface of the rear of the vehicle;
(2) a frame affixed to said hub such that the frame rotates with said hub; said frame having the general shape of an open rectangle and the open portion of said frame having a length and a width with the width being slightly wider than the thickness of the tire to be transported and the length being slightly shorter than the width of the tire to be transported such that a tire placed within said frame is supported by said frame with most of the tire being above said frame and said tire being parallel with the rear surface of the vehicle; and
(3) locking means for locking said hub in a position in which said frame is generally horizontal and the locking means may be unlocked such that said hub may rotate until one end of said frame touches the ground;
whereby said locking means may be unlocked and said hub rotated until one end of said frame touches the ground, a tire may be rolled onto said frame, said hub may be rotated until said frame is generally horizontal, and said locking means may be locked such that the tire may safely be transported.

2. The tire carrier of claim 1 in which the affixing means is a post which may be inserted into and removably affixed to the receiver of a conventional trailer hitch on the vehicle.

3. The tire carrier of claim 1 in which a bracket is removably affixed to said hub, the bracket having the general shape of a “U” which opens toward the center of the tire and secures the tire within said frame, and said frame is removed when a tire is loaded onto or unloaded from said frame.

4. The tire carrier of claim 2 in which a bracket is removably affixed to said hub, the bracket having the general shape of a “U” which opens toward the center of the tire and secures the tire within said frame, and said frame is removed when a tire is loaded onto or unloaded from said frame.

5. A tire carrier which may be affixed to a conventional vehicle and used to load, unload, or transport a tire, comprising:
(1) a hub and affixing means for affixing the hub to the front of a vehicle; said hub being capable of rotating in the plane of the surface of the rear of the vehicle;
(2) a frame affixed to said hub such that the frame rotates with said hub; said frame having the general shape of an open rectangle and the open portion of said frame having a length and a width with the width being slightly wider than the thickness of the tire to be transported and the length being slightly shorter than the width of the tire to be transported such that a tire placed within said frame is supported by said frame with most of the tire being above said frame and said tire being parallel with the rear surface of the vehicle; and
(3) locking means for locking said hub in a position in which said frame is generally horizontal and the locking means may be unlocked such that said hub may rotate until one end of said frame touches the ground;
whereby said locking means may be unlocked and said hub rotated until one end of said frame touches the ground, a tire may be rolled onto said frame, said hub may be rotated until said frame is generally horizontal, and said locking means may be locked such that the tire may safely be transported.

6. The tire carrier of claim 5 in which the affixing means is a post which may be inserted into and removably affixed to the receiver of a conventional trailer hitch on the vehicle.

7. The tire carrier of claim 5 in which a bracket is removably affixed to said hub, the bracket having the general shape of a “U” which opens toward the center of the tire and secures the tire within said frame, and said frame is removed when a tire is loaded onto or unloaded from said frame.

8. The tire carrier of claim 7 in which a bracket is removably affixed to said hub, the bracket having the general shape of a “U” which opens toward the center of the tire and secures the tire within said frame, and said frame is removed when a tire is loaded onto or unloaded from said frame.
